(19) United States
(12) Patent Application Publication
(10) Pub. No.: US 2009/0097369 A1
(43) Pub. Date: Apr. 16, 2009

(54) Method for adjusting recording power

(75) Inventors: Shih-Kuo Chen, Taoyuan County (TW); Chin-Fa Hsu, Taoyuan County (TW); Ming-Hung Chen, Taoyuan County (TW); Shiu-Ming Chu, Taoyuan County (TW)

Correspondence Address: BACON & THOMAS, PLLC, 625 SLATERS LANE, FOURTH FLOOR, ALEXANDRIA, VA, 22314-1176, US

(73) Assignee: QUANTA STORAGE INC., Taoyuan County (TW)

(21) Appl. No.: 12/219,183

(22) Filed: Jul. 17, 2008

(30) Foreign Application Priority Data
Oct. 12, 2007 (TW) 96138554

(51) Int. Cl. G11B 7/00

(52) U.S. Cl. 369/47.53

(57) ABSTRACT

A method for adjusting recording power is provided. The addresses of changing recording velocity and section pause points are set. Then, the recording power in the inner circle is tested with the lowest rate, and the recording power on each high rate area is estimated. A required record data is recorded. Afterwards, whether the recording of the required record data is completed is determined. If confirmed, the recording process is terminated; otherwise, whether the recording velocity needs to be changed is determined. If confirmed, the recording is paused to change the recording velocity, otherwise, the recording process continues. The recording of required record data continues according to the estimated recording power and the recording power is tested to obtain an optimum recording power. Next, the recording power is adjusted to the optimum recording power to continue recording the rest of required record data, so as to enhance the recording quality.

This application claims the benefit of Taiwan application Serial No. 96138554, filed Oct. 12, 2007, the subject matter of which is incorporated herein by reference.

### BACKGROUND OF THE INVENTION

1. Field of the Invention

The invention relates in general to a method for adjusting recording power, and more particularly to a method for adjusting recording power that assures the recording quality by way of testing the recording power when the disc driver switches recording velocity.

2. Description of the Related Art

Recordable disc records data with the digital signals of 0 and 1 that are formed when the laser beam emitted from the pick-up head is projected onto the disc and forms marks of indentions or phase changes which cause variation in the light amount of the reflective light. Thus, the clarity of the marks on the disc is determined according to the power of the laser beam and the duration of projection of the laser beam.

When the constant rotation speed and the rotation speed of a disc are slower, the time of the projection of the laser beam is longer, and the clarity and consistency of the formed marks is better. However, if the rotation speed is too slow, the recording time will be prolonged, and the recording efficiency of the disc driver is reduced. To reduce the recording time, as indicated in the conventional recording process of disc in FIG. 1, a disc 2 is rotated via a spindle motor 1. A pick-up head 3 moves along the radial direction of the disc 2 and projects a laser beam onto the disc 2. According to the characteristics of disc rotation, the disc 2 is divided into several different data transfer rate areas which change from a low data transfer rate corresponding to an inner circle to a high data transfer rate corresponding to an outer circle. Examples of the data transfer rates include 2×, 4×, 6×, 8× and so on. The increase of the recording velocity in the outer circles shortens the overall recording time.

As there are plenty of manufacturers of the disc 2, and the discs 2 of different manufacturers differ in the material, composition and manufacturing process of the disc, the discs 2 of the manufacturers have different reaction to the laser beam. Therefore, the conventional disc 2 has a test area 4 for laser beam power in the beginning of the data area of inner circle. When the disc driver is at low data transfer rate 2×, test recording is performed according to various pre-determined test data and modes with different recording power and marks of different lengths. Next, the recording marks are read. To evaluate the clarity of various recording marks, a test-recording quality parameter (that is, beta parameter) is calculated as a reference of the recording quality according to the amount of the reflective light from various recording marks, the accuracy of decoding, and the intensity of the signal etc. An optimum recording power applicable to the disc is then selected based on the test-recording quality parameter. This process is called optimum power control (OPC). Furthermore, the recording power of each high data transfer rate is estimated from the 2× data transfer rate for the recording of a required record data.

However, the recording power of high data transfer rate is directly estimated from the recording power tested at low data transfer rate rather than obtained from actual recording. Therefore, it is not easy to control the recording quality of the disc at high data transfer rate. If the test of optimum power control is performed on each high data transfer rate area, each high data transfer rate area needs to have a test area, hence decreasing the storage capacity of the disc. Also, the test data and mode for each high data transfer rate needs to be prepared and transmitted, the recording of required record data is thus interrupted for switching the recording area, not only easily resulting in the loss of the recorded data but also increasing the recording time, further affecting the efficiency of recording. Therefore, the conventional method of recording disc still has many problems to be resolved regarding the adjustment of the recording power.

### SUMMARY OF THE INVENTION

The invention is directed to a method for adjusting recording power that adjusts the optimum recording power to assure the recording quality by directly testing the recording power in various recording velocities.

According to a first aspect of the present invention, a method for adjusting recording power is provided. The method tests the recording power of various recording velocities with the required record data to assure that the required record data will not be lost and the storage capacity of the disc is maintained.

According to a second aspect of the present invention, a method for adjusting recording power is provided to test and adjust the recording power on small section, so as to control the recording power instantly and accurately and to obtain better recording power as well as avoid the increasing of recording time.

In order to achieve the above objects of the invention, a method for adjusting recording power is provided. Firstly, the address of changing recording velocity and the address of section pause points are set. Next, the recording power on the test area of an inner circle is tested with the lowest date transfer rate, and the recording power of each high data transfer rate area is estimated. Then, a required record data is sequentially recorded and the recording process is monitored. Afterwards, when the recording of the required record data is completed, the recording process is terminated. Otherwise, the address of changing recording velocity is monitored and whether the recording velocity needs to be changed is determined. If confirmed, the recording is paused and the recording velocity is changed; otherwise, the recording process continues. Then, the recording of the required record data continues according to the estimated recording power and the section recording power is tested to generate an optimum section recording power. Lastly, the recording power is adjusted to the optimum recording power, and the recording of the rest of the required record data continues so that the recording quality is improved.

In the step of testing the section recording power according to the method for adjusting recording power of the invention, a section comprises a plurality of small sections and pause points. The test on the first small section of the section is performed by way of recording the required record data according to the estimated recording power until the pause point of small section is reached, and then the recording quality on the section is read. Next, the recording power is adjusted with a pre-determined variation according to the read recording quality, and is used as the recording power on the next small section to test the recording power, so as to approximate a better recording power.

The invention will become apparent from the following detailed description of the preferred but non-limiting embodiments. The following description is made with reference to the accompanying drawings.

### BRIEF DESCRIPTION OF THE DRAWINGS

FIG. 1 shows a conventional disc recording process;

FIG. 2 shows a process of adjusting the recording power according to a first embodiment of the invention;

FIG. 3 is a flowchart of a method for adjusting recording power according to the first embodiment of the invention;

FIG. 4 shows a process of adjusting the recording power according to a second embodiment of the invention; and

FIG. 5 is a flowchart of the method for adjusting recording power according to the second embodiment of the invention.

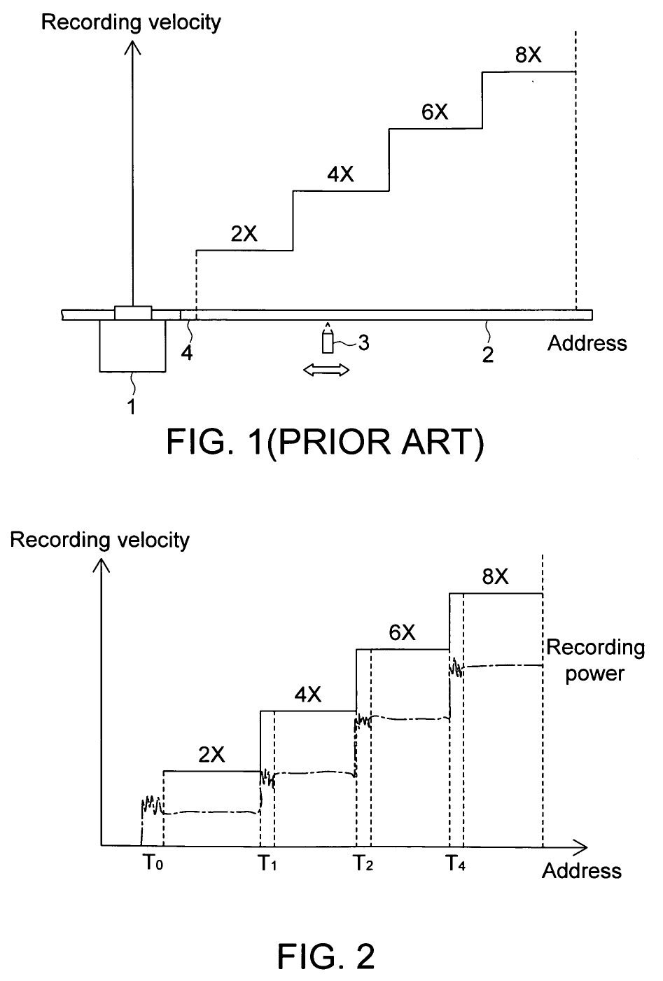

### DETAILED DESCRIPTION OF THE INVENTION

Referring to FIG. 2, a process of adjusting the recording power according to a first embodiment of the invention is shown. The recordable disc according to the method of the invention is divided into a plurality of areas with different constant data transfer rates which change from a low data transfer rate in an inner circle to a high data transfer rate in an outer circles. Examples of the data transfer rate include 2×, 4×, 6×, 8× and so on. The neighboring change address of a date transfer rate area can be determined according to the speed of the wobbled signal generated from different locations in the radial direction of the disc when the disc rotates in a constant angular velocity. For the laser beam power test area T0 at the beginning of the data area of the inner circle of the disc, the invention adopts an optimum power control method to measure the optimum power of the low data transfer rate 2× according to a pre-determined test data and mode when the disc rotates at 2× low data transfer rate. Then the recording power of each high data transfer rate is estimated according to the optimum power measured at 2× data transfer rate. The above estimation method is based on previous experience of using the disc. Despite the estimated recording power being within an acceptance range, it is not guaranteed that the recording quality becomes better.

Since the estimated value of the recording power has reduced the range of the optimum recording power, a better recording power is thus obtained by adjusting the estimated value of the recording power with a small range for a few times. There is no necessary to record the entire pre-determined test data and mode on a large test area like the test area of inner circles for comparison and testing so as to obtain the optimum recording power. Thus, when the recording velocity is switched, the invention uses the estimated value of the recording power as a basis to set a small section such as T1 to T4 at the beginning of each date transfer rate area, and adjusts the estimate values with the pre-determined variation for a few times to sequentially record the required record data as a recording power test. There is no need to pause the normal recording for too long to record numerous test data, avoiding the waste of storage capacity and pausing time of the disc. In the embodiment of the invention, the recording process is monitored so that the recording is paused when a pre-determined pausing address of a section is reach, the recording quality on each mark of the section is then read and an optimum recording power is obtained according to the comparison of the recording quality and is used as the recording power of the recording velocity. The recording power is accordingly adjusted to continue the recording of the rest of the required record data, so as to assure that the subsequent recorded data is of better recording quality.

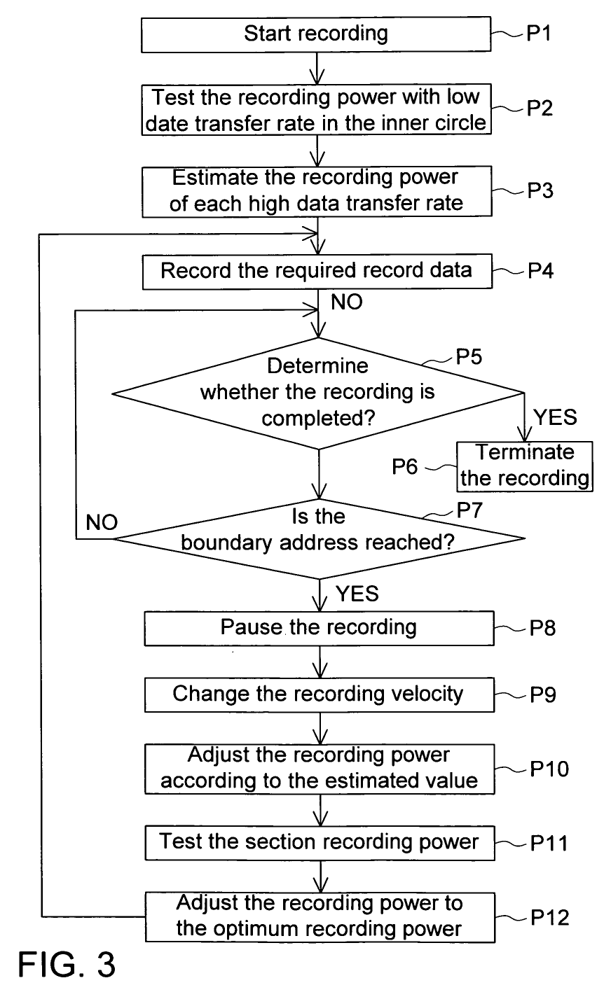

FIG. 3 is a flowchart of a method for adjusting recording power according to the first embodiment of the invention. The steps of performing the test of recording power according to the estimated value under each recording velocity so as to obtain an optimum recording power to increase the recording quality are disclosed below.

The method for adjusting recording power according to the embodiment of the invention begins at step P1 of recording a disc. Firstly, the disc is divided into a plurality of areas with different constant data transfer rates which change from a low data transfer rate in an inner circle to a high data transfer rate in an outer circles, the boundary addresses between the areas of different data transfer rates and the pause point address of the small test section starting from each boundary address are set. Next, the method proceeds to step P2, at the beginning of the data area in the inner circle of the disc, the recording power is tested according to the pre-determined test data and mode with the lowest date transfer rate to obtain an optimum recording power of the lowest date transfer rate. Then, the method proceeds to step P3, the recording power of each high data transfer rate is estimated according to the obtained optimum recording power of the lowest date transfer rate. After that, the method proceeds to step P4, the required record data is sequentially recorded onto the disc starting from the lowest date transfer rate area of the innermost circle.

The recording of data continues to be monitored during the recording process. In step P5, whether the recording of the required record data is completed is determined. If confirmed, the method proceeds to step P6 that the recording process is terminated. Otherwise, the method proceeds to step P7, the recording process continues and whether the boundary address of data transfer rate of recording velocity that needs to be changed is reach is determined. If the boundary address of data transfer rate area has not been reached, then the method returns to step P4 to continue the recording process. Otherwise, the method proceeds to step P8 to pause the recording process. Next, the method proceeds to step P9, the recording velocity of low data transfer rate is boosted to the recording velocity of the next higher date transfer rate area. Then, the method proceeds to step P10, the recording power is adjusted to the recording power of the high data transfer rate that is estimated in step P3. Next, the method proceeds to step P11, the recording of the required record data continues according to the adjusted recording power, and the recording power is adjusted within the pre-determined variation. The recording of the required record data continues until the address of section pause point is reached. When the recording process pauses, the required record data on this section is read so as to obtain an optimum recording power based on the read recording quality. Lastly, the method proceeds to step P12, the recording power is adjusted to the optimum recording power, and then returns to step P4 to continue recording the rest of the required record data.

The method for adjusting recording power according to the invention, by means of the high data transfer rate recording power estimated from the low data transfer rate recording power, continues to record the required record data without interruption when the recording velocity is changed, and directly tests the high data transfer rate recording power according to the recording quality of the required record data recorded in the beginning of each high data transfer rate section so as to boost the recording power to the optimum recording power and improve the recording quality on the subsequent data recorded at high data transfer rate.

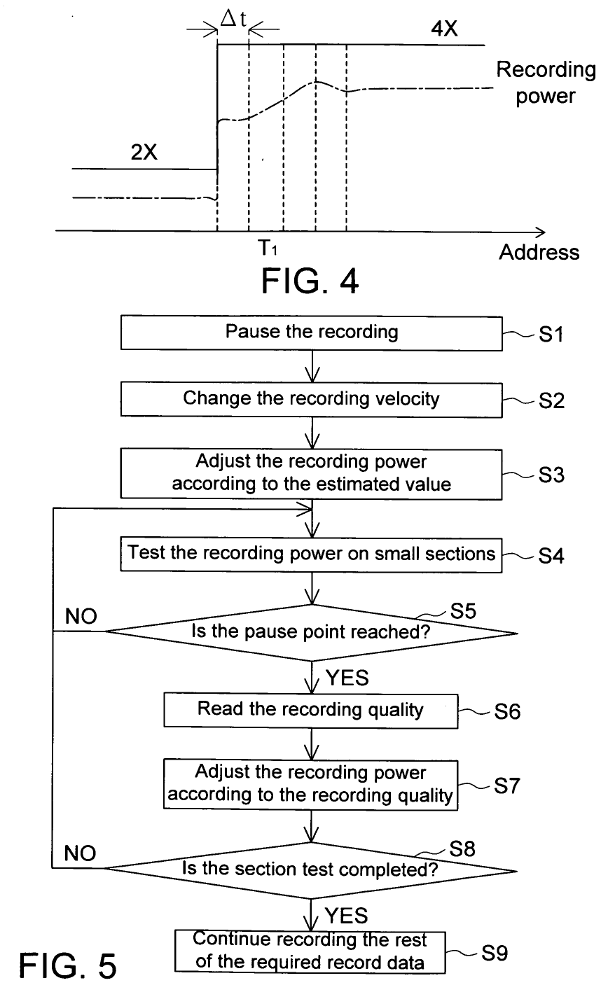

FIG. 4 shows a process of adjusting the recording power according to a second embodiment of the invention. The present embodiment of the invention is the same as the first embodiment of the invention in the steps of recording a plurality of date transfer rate areas, setting the boundary address, testing the optimum recording power with the lowest date transfer rate in the inner circle, estimating the recording power of each high data transfer rate area, and monitoring the change in the recording velocity and the completion of recording. The present embodiment of the invention differs from the first embodiment of the invention in the way of testing the beginning section of each high data transfer rate. In the present embodiment of the invention, each high data transfer rate section is further divided into smaller record sections that are tested one by one. That is, the recording power of the present small section is adjusted according to the recording quality of the previous small section, so as to approximate the optimum recording power of each high data transfer rate.

Let the 2× to 4× data transfer rates be taken for example. The test section T1 of 4× data transfer rate is divided into 4 small sections Δt in advance, wherein each small section Δt has a corresponding address of its own pause point. When the address of changing recording velocity for the 2× data transfer rate is reached, the disc driver pauses the recording to switch to the recording velocity of 4× data transfer rate. Then, the disc driver, according to the estimated recording power of each high data transfer rate, adjusts the recording power to continue the recording of the required record data in the first small section Δt. When the pause point address of the first small section Δt is reached, the disc driver pauses the recording to read the recording quality of the first small section Δt, and then the disc driver boosts or decreases the recording power within a pre-determined variation according to the read recording quality. Next, the disc driver proceeds to the second small section Δt, continues to record the required record data, and determines to increase or decrease the recording power according to the recording quality. The process is repeated until the disc driver proceeds to the last small section Δt to adjust the recording power according to the recording quality and continues the recording of the rest of the required record data.

FIG. 5 is a flowchart of the method for adjusting recording power according to the second embodiment of the invention. In each data transfer rate section, the detailed steps of adjusting the recording power according to the recording quality of each small section so as to enhance the recording quality are disclosed below.

During the recording process of the invention, in step S1, the recording of disc is paused when the boundary address of data transfer rate is reached. Next, the method proceeds to step S2, the recording velocity is changed, that is, the recording velocity of low data transfer rate is adjusted to the recording velocity of the next higher date transfer rate area. Then, the method proceeds to step S3, the recording power is boosted to the estimated recording power of high data transfer rate. Next, the method proceeds to step S4 of testing the recording power on small sections. In step S4, the recording of the required record data continues according to the adjusted recording power. After that, the method proceeds to step S5, whether the pause point address of small section is reached is determined. If the pause point is not reached, then the method returns to step S4 to continue the test of recording power on small sections. If the pause point is reached, then the method proceeds to step S6, the disc driver pauses the recording to read the recording quality of the required record data in the small section. Next, the method proceeds to step S7, the recording power is adjusted according to the recording quality read in step S6. Then the method proceeds to step S8 to determine whether the address of completing the section test is reached. If confirmed, the method proceeds to step S9 to continue recording the rest of the required record data. Otherwise, the method returns to step S4 to continue the test of recording power on the small section.

The method for adjusting recording power according to the invention adjusts the test of the recording power on small section instantly and accurately by approximating to the optimum recording power. Besides, when the recording velocity is changed, the recording of the required record data continues without the situation of switching the test data mode, so the problem that the required record data is lost during the switch of test data is avoided. Also, the recording power is tested directly with the recording of the required record data. There is no need to reserve the test section for high data transfer rates, maintaining the storage capacity of a disc.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for adjusting recording power, comprising the steps of:
(1) setting the address of changing recording velocity and the address of section pause points;
(2) testing the recording power on the test area of an inner circle with the lowest date transfer rate and estimating the recording power on each high data transfer rate area;
(3) sequentially recording a required record data and monitoring the recording process;
(4) determining whether the recording of the required record data is completed, wherein if confirmed, the recording process is terminated, otherwise the method proceeds to the next step;
(5) determining whether the address of changing recording velocity is achieved, wherein if confirmed, the method proceeds to the next step, otherwise the method returns to step (3) to continue recording the required record data;
(6) pausing the recording to change the recording velocity;
(7) continuing recording the required record data according to the estimated recording power and testing the section recording power to generate an optimum recording power; and
(8) adjusting the recording power to the optimum recording power and returning to step (3) to continue recording the rest of the required record data.

2. The method for adjusting recording power according to claim 1, wherein in the step (2), the recording power on the test area of inner circles is tested with the lowest date transfer rate according to a pre-determined test data and mode.

3. The method for adjusting recording power according to claim 1, wherein in the step (3), the required record data is sequentially recorded from the lowest date transfer rate area in the innermost circle to the highest date transfer rate area in the outermost circle.

4. The method for adjusting recording power according to claim 1, wherein in the step (5), the address of changing recording velocity is the boundary address of each data transfer rate.

5. The method for adjusting recording power according to claim 1, wherein in the step (7) of testing the section recording power, the test is executed by continually recording the required record data with the estimated recording power which is adjusted within a pre-determined variation.

6. The method for adjusting recording power according to claim 5, wherein in the test of section recording power, when the address of section pause point is reached, the recording is paused and the recording quality on the section is read instead.

7. The method for adjusting recording power according to claim 6, wherein the optimum recording power is determined according to the recording quality of the read section.

8. The method for adjusting recording power according to claim 1, wherein the step (1) of setting section comprises the step of setting a plurality of small sections and pause points.

9. The method for adjusting recording power according to claim 8, wherein in the step (7) of testing section recording power, the test is executed with a small section recording power.

10. The method for adjusting recording power according to claim 9, wherein the test of recording power on the first small section of the section continues to record the required record data according to the estimated recording power.

11. The method for adjusting recording power according to claim 9, wherein in the test of recording power on the small section, when the pause point address of small section is reached, the recording is paused and the recording quality on the small section is read instead.

12. The method for adjusting recording power according to claim 9, wherein in the test of the present small section recording power, the recording power is adjusted within a pre-determined variation according to the recording quality of the previous small section.
